(19) United States
(12) Patent Application Publication
(10) Pub. No.: US 2015/0222639 A1
(43) Pub. Date: Aug. 6, 2015

(54) Maintaining Continuous Operational Access Augmented with User Authentication and Action Attribution in Shared Environments

(71) Applicant: Cyber-Ark Software Ltd., Petach Tikva (IL)

(72) Inventors: Andrey Dulkin, Herzelia (IL); Yair Sade, Herzelia (IL)

(73) Assignee: Cyber-Ark Software Ltd., Petach Tikva (IL)

(21) Appl. No.: 14/110,155

(22) PCT Filed: Oct. 1, 2013
(86) PCT No.: PCT/IL2013/050809

§ 371 Date: Oct. 7, 2013

Related U.S. Application Data
(60) Provisional application No. 61/716,641, filed on Oct. 22, 2012.

(51) Int. Cl. H04L 29/06; G06F 21/31

(52) U.S. Cl. CPC H04L 63/105; G06F 21/31; H04L 63/08

(57) ABSTRACT

A system and method for maintaining continuous operational access augmented with user authentication and action attribution in shared environments. Multiple users use the same machine/platform to perform their actions. The system includes an access control application and enforcement module that limit users' actions based on authentication and authority level, enabling each user to perform the user's role in the shared environment. In addition, the user's activities can be monitored, logged, and interfered with (such as terminating the session), enabling a key requirement of action attribution.

### CROSS-REFERENCE TO RELATED APPLICATIONS

This application claims the benefit of provisional patent application (PPA) U.S. Ser. No. 61/716,641, filed Oct. 22, 2012 by the present inventors, which is incorporated by reference.

### FIELD OF THE INVENTION

The present invention generally relates to access control, and in particular, it concerns maintaining continuous multi-level access.

### BACKGROUND OF THE INVENTION

A long-standing problem in operational control centers is the crucial need to maintain continuous operational control, while providing for authenticating and attributing actions to a specific user in a shared environment. A typical current setup for an operational control center includes systems that control the process and the infrastructure, display the situation, and enable continuous operational access to the infrastructure element (an operational control system (OCS)). In such centers, the employees (users) typically work in shifts, monitoring and controlling systems through a set of applications. The users perform their roles on the same systems, meaning the users are using shared environments—the user who finishes his shift is replaced with another user who begins his shift, in the same role, on the same system.

Typically, the most important aspect of this operational control is timely response to alarms (alerts) and triggers. Other needs in such environments are the need to authenticate the user of the system and the need to attribute the actions performed in the shared environment to the specific user who performed these actions. However, due to the criticality of the need for timely response, the authentication must not interfere with timely operations. Often, it is more important for the user to be able to act and control, than to be properly authenticated. In other words, it is often more important that the right action is done in time, than to know who did the action.

Existing conventional systems of authentication prevent users from performing actions prior to authentication process completion, thus conventional systems are unsuitable to meet the needs of these critical environments.

Action attribution refers to the knowledge that a specific action was performed by a specific user. This is required for incident resolution, collection of forensic evidences, enforcement of business procedures and workflows, as well as various other needs. Another purpose of action attribution is to ensure accountability—a user will be held accountable for the actions the user performed. In conventional information systems, attribution is achieved by authenticating the user and subsequently tagging the actions performed by this user with a tag that enables attribution to the authenticated user. Existing authentication and attribution solutions rely on authentication at one of the following three stages:
On system login—when a user logs into an environment, the user is authenticated and the user's environment identity is used for attributing subsequent actions.
On application login—when a user logs into a specific application, the user is authenticated and the user's application identity is used for attribution.
On performing an action or running a command—when a user wishes to perform a specific action, the user authenticates, and this specific command can be attributed to this specific user.

The above-described attribution solutions are unsuitable in critical environments, where shift workers operate the same station and a common procedure is that a worker who finishes shift hands over the station to the worker's replacement. The above-describe attribution solutions are unsuitable because these solutions either:

Require the leaving worker to log-off (the environment or the application) and the new worker to log in—this prevents continuous monitoring, as the screens do not appear on the workstation during log-off time, and are inaccessible in the “dead” period between the worker logout and the worker's replacement login
Require the operator to authenticate before an action can be performed—this significantly damages the workflow and can be unacceptable in critical environments, where immediate action is required. A timely response in such environment is often more important than user authentication and action attribution.

The problem of accountability and user authentication in critical environments is well acknowledged in various CI (Critical Infrastructure) regulations and standards, such as NERC (North American Electric Reliability Corporation) CIP (Critical Infrastructure Protection) regulation CIP-007 Requirement 5 (CIP-007-5). This regulation requires entities to establish, implement, and document technical and procedural controls that enforce access authentication of—and accountability for—all user activity, and that minimize the risk of unauthorized system access. These controls ensure user permissions are consistent with need-to-know information and prevent shared access of user accounts that do not have audit trails.

Multiple compliancy reports for NERC CIP (for example, NERC—Reliability Coordinator Compliance Analysis Report, May 2013) show failure to comply with these requirements, including failure to ensure accountability for all user activity, failure to enforce sufficiently complex passwords, and, most notably, not managing the scope and acceptable use of administrator, shared and other privileged accounts. Many organizations use shared accounts to overcome the continuous operation challenge—the need to constantly monitor and operate a system—which does not allow logging-off and switching between accounts.

NERC CIP recognizes this challenge and specifically addresses this challenge by stating that “Entities should take caution when configuring account lockout to avoid locking out accounts necessary for the bulk electric system (BES) Cyber System to perform a BES reliability task. In such cases, entities should configure authentication failure alerting” (NERC CIP-007-5).

Current solutions that address this problem (for example, Foxguard Solutions Access Management and NEMS) address the need for complex passwords and specific user authentication. They do so by managing specific accounts (for example, through integration with domain controllers, such as Active Directory) and forcing a user to complete authentication on log-on (either to system or application), prior to being able to perform any action in the system (FIG. 2A). Alternatively, if authentication fails, some solutions may enable operation to support continuous access, but send an alert to a notification or alerting system (FIG. 2B). In addition, in this case of failed authentication, the user continues to operate without authentication, and the full range of operations is enabled and no limitations are enforced on user actions.

Other products (for example, nCircle Configuration Compliance Manager) provide a report to the organization on the compliance state, highlighting and alerting when a compliance criterion is not met. For example, when the passwords are not sufficiently complex or when there are no specific user accounts and there is a prevalent use of shared accounts, which do not provide for accountability. These conventional solutions do not enforce authentication or accountability, but mainly alert on non-compliance.

Other conventional products include:

Kiosk software—used in kiosks or Internet kiosks to provide information and a limited set of actions to a user. Various means are employed by the kiosk software to limit the kiosk functionality and prevent the user from acting outside of the intended scope and abusing the kiosk system. However, the purpose of kiosk software is to limit the user to a specific application and not to authenticate the user, authorize the user to use the kiosk application, or prevent the user from interacting with the kiosk application.

Secondary authentication and monitoring solutions—after a user logs into an environment with a shared identity, the user is presented with a secondary authentication screen, where the user uses a personal ID, which is then used to permit the user's usage of the environment and attributes all subsequent actions to this user. An example solution is offered by ObserveIT, called Forced-Identification. Such solutions prevent interaction with the environment or applications until authentication is performed.

Lock/unlock workstation—existing solutions (such as Microsoft's Windows) enable workstation lock after a period of inactivity or on user command. The workstation remains in a locked state, until unlocked by user re-authenticating or a different user connecting to the station. While in locked state, the environment is obscured by either a screen-saver or a login screen, thus previously presented applications and screens are not visible and user activity is disabled until authentication is performed.

Lock/unlock application—some applications provide a built-in lock/unlock functionality, after a period of inactivity or on user command. Most implementations change the application appearance, switching from the screens previously presented to the user to a different, log-on screen. Selected implementation “gray-out” the presented screen and present a log-on dialog. All implementations require a user re-authentication or log-on to enable user activity in the application.

US patent application 2005/066202 to Evans teaches a system for providing multiple concurrent desktops and workspaces in a shared computing environment, wherein the users can each have a separate desktop that allows the users to login simultaneously, or even switching of desktop logins, without terminating the associated desktop threads. This system limits users' actions based on the authentication level. Evans does not teach continuously maintaining/monitoring of operational access and control, and specifically, does not provide for user actions until the user has completed the authentication step.

There is therefore a need for a system and method for maintaining continuous multi-level access to an operational control system.

### SUMMARY

According to the teachings of the present embodiment there is provided a method including the steps of: providing a user a first level of access to a shared environment; receiving a first trigger while providing the first level of access; providing the user a second level of access to the shared environment based on the first trigger and access rules; receiving a second trigger while providing the second level of access; providing the user a third level of access to the shared environment based on the second trigger and the access rules, wherein at least a pre-determined level of continuous access to the shared environment is provided to the user during transition: from the first level of access to the second level of access; and from the second level of access to the third level of access.

According to the teachings of the present embodiment there is provided a system including: a rules module configured to receive, store, and provide access rules; a trigger module configured to receive, store, and provide triggers; an enforcement module operational to control user input based on an access level, the enforcement module providing a user a first level of access to a shared environment; an access control application module (ACA) operationally connected to the rules module, the trigger module, and the enforcement module, the ACA configured to: receive a first trigger from the trigger module while the first level of access is being provided; based on the first trigger, receive a first access rule from the rules module; based on the first access rule, initiate the enforcement module to provide the user a second level of access to the shared environment; based on a second trigger, receive a second access rule from the rules module while the second level of access is being provided; based on the second access rule, initiate the enforcement module to provide the user a third level of access to the shared environment; wherein at least a pre-determined level of continuous access to the shared environment is provided to the user during transition: from the first level of access to the second level of access; and from the second level of access to the third level of access.

In an optional embodiment, the enforcement module monitors user input. In another optional embodiment, a monitoring module is configured to monitor user input.

In an optional embodiment, the system further includes an authentication module operationally connected to the trigger module and configured to send triggers to the trigger module based on success or failure of the user to authenticate. In an optional embodiment, the system further includes a logging module configured to receive, store, and/or transmit data from one or more of the modules.

In an optional embodiment, the first and second triggers are selected from the group consisting of
(i) time of day;
(ii) idle time of the shared environment;
(iii) idle time of an operational control system (OCS) associated with the shared environment;
(iv) authentication of the user;
(v) failure of the user to authenticate;
(vi) login of any user to the shared environment;
(vii) logout of any user from the shared environment;
(viii) time since the user was requested to authenticate;
(ix) change in status of the shared environment;
(x) change in status of an operational control system (OCS) associated with the shared environment;
(xi) action or actions of the user in the shared environment
(xii) action or actions of the user associated with an operational control system (OCS) associated with the shared environment;
(xii) command external to the shared environment;
(xiii) any system trigger based on the access rules; and
(xiv) a combination of triggerable events.

In an optional embodiment, the second trigger is: an indication the user has authenticated to the shared environment; or is an indication the user has failed authentication to the shared environment; or is based on the access rules.

In an optional embodiment, the first level of access includes allowing any user the pre-determined level of continuous access to the shared environment. In an optional embodiment, the first level of access includes allowing the user the pm-determined level of continuous access to the shared environment while the user is unauthenticated. In an optional embodiment, while the second level of access is being provided, the user is required to authenticate for the third level of access.

In an optional embodiment, if the user is successful in authenticating, the third level of access is provided; and if the user fails authentication a fourth level of access is provided based on the access rules. In an optional embodiment, a third trigger is received indicating that the user has logged out from the shared environment, and the first level of access is provided to a subsequent user of the shared environment.

In an optional embodiment, the actions of a current user are logged and attributed to the current user. In an optional embodiment, the actions of a current user are monitored and attributed to the current user. In an optional embodiment, user actions are prevented or changed according to the access rules or an external command.

In an optional embodiment, access is provided such that:
(a) the second level of access is the first level of access; or such that
(b) the third level of access is the second level of access; or such that
(c) the first level of access is the pre-determined level of continuous access; or such that
(d) the second level of access is the pre-determined level of continuous access; or such that
(e) the third level of access is the pre-determined level of continuous access; or such that
(f) the first level of access is an unauthenticated level of access; or such that
(g) the second level of access is an unauthenticated level of access; or such that
(h) the third level of access is an authenticated level of access.

In an optional embodiment, a Privileged Account Management System (TAMS) provides at least one of: the access rules; authentication to the user while the second level of access is being provided; logging and attribution of actions of the user; and monitoring and attribution of actions of the user.

In an optional embodiment, the user is a human. In an optional embodiment, the user is a computer application. In an optional embodiment, the shared environment is a computer system.

According to the teachings of the present embodiment there is provided a computer-readable storage medium having embedded thereon computer-readable code for providing access, the computer readable code including program code for: providing a user a first level of access to a shared environment; receiving a first trigger while providing the first level of access; providing the user a second level of access to the shared environment based on the first trigger and access rules; receiving a second trigger while providing the second level of access; providing the user a third level of access to the shared environment based on the second trigger and the access rules, wherein at least a pre-determined level of continuous access to the shared environment is provided to the user during transition: from the first level of access to the second level of access; and from the second level of access to the third level of access.

According to the teachings of the present embodiment there is provided a computer program that can be loaded onto a server connected through a network to a client computer, so that the server running the computer program constitutes a server in a system implementing any one of the above method claims.

According to the teachings of the present embodiment there is provided a computer program that can be loaded onto a computer connected through a network to a server, so that the computer running the computer program constitutes a client computer in a system implementing any one of the above method claims.

### BRIEF DESCRIPTION OF FIGURES

FIG. 1, a diagram of conventional access to an operational control system (OCS).

FIG. 2A, a flowchart of forcing a user to complete authentication on log-on prior to being able to perform any action in the system.

FIG. 2B, a flowchart of forcing a user to complete authentication on log-on prior to being able to perform any action in the system.

FIG. 3, an example implementation of a system for providing continuous access and user authentication in shared environments.

FIG. 4, a high-level flowchart of a method for providing continuous access to a shared environment.

FIG. 5, a non-limiting exemplary flowchart of a method for providing continuous access to a shared environment, in this example to an operational control system (OCS).

FIG. 6 is a high-level partial block diagram of an exemplary processing system for implementing a shared environment authentication system (SEAS).

### ABBREVIATIONS AND DEFINITIONS

For convenience of reference, this section contains a brief list of abbreviations, acronyms, and short definitions used in this document. This section should not be considered limiting. Fuller descriptions can be found below, and in the applicable Standards.

ACA—access control application, a primary module of the current embodiment, responsible for holding state and making decisions.

Access rules—rules and/or configurations defining what authority a user can be given.

Accountability—acknowledgment and assumption of responsibility for actions by a user.

Alert—a signal, including but not limited to email, phone call, SMS (short message service), video pop-up, activation of an indicator (such as turning on a light), and/or activation of an audio alarm, etc.

Attribution/action attribution—the knowledge that a specific action was performed by a specific user.

Authentication—verification that a user is really who the user claims to be.

Authority—level of access allowed to the user, including permissions and/or allowable user operations.

BES—Bulk electric system.

CI—Critical Infrastructure.

CIP—Critical Infrastructure Protection.

Enforcement module—a primary module of the current embodiment, responsible for enforcing limitations.

Minimum level of access—typically an access level greater than “none” that is the lowest level of authority available to all users.

Multi-level access—typically access by more than one user to a system, with each authenticated and un-authenticated user able to have a different level of authority during access to the system, and typically at all times a minimum level of access/authority.

NERC—North American Electric Reliability Corporation.

OCS—operational control system. The portion of the system that enables user interaction and control (authority), accepting user commands to control the system, and returning feedback from the system for the user.

SEAS—Shared Environment Authentication System.

Pre-determined level of continuous access—a level of access defined prior to user authentication that any user has at any time. Typically the minimum level of access.

Privileged Account Management System (PAMS)/PIMS, Privileged Identity Management System)—a system that manages privileged accounts and access in accordance with organizational policy, typically by controlling and managing the credentials to privileged accounts. Main features include user authentication, mapping of which users are allowed usage of which privileged account and logging of privileged accounts usage. An example of PAMS is the PIM/PSM suite by CyberArk.

Shared environment—environment potentially accessed by multiple users, running applications such as OCS, which require continuous access.

Trigger—an event in the shared environment.

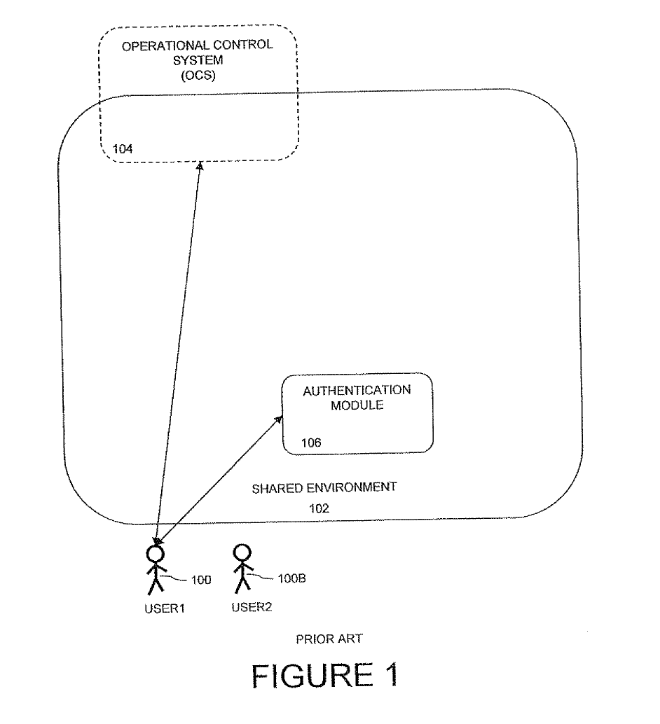

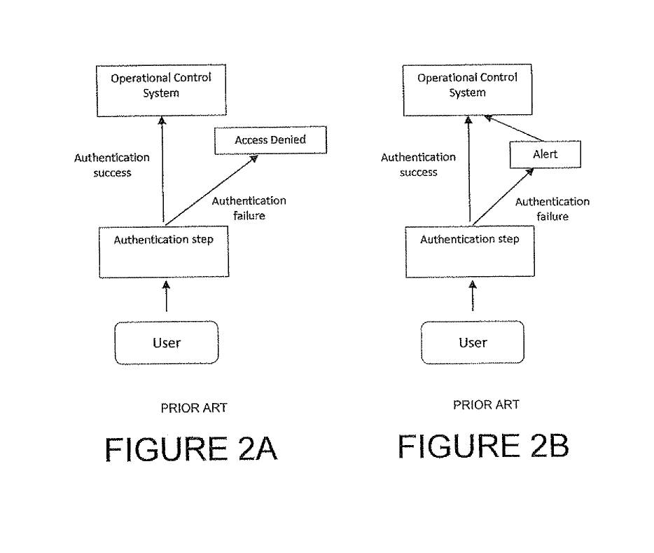

### DETAILED DESCRIPTION—FIGS. 1 to 6

The principles and operation of the system according to a present embodiment may be better understood with reference to the drawings and the accompanying description. A present invention is a system and method for maintaining continuous operational access augmented with user authentication and action attribution in shared environments. The present embodiment features a system for maintaining continuous operational access and control augmented with user authentication in a shared environment, where multiple users use the same machine/platform to perform their actions. The system includes an access control application that limits the user's action based on authentication and authority level, enabling the user to perform the user's role in the shared. environment. In addition, the user's activities can be monitored, logged, and interfered with (such as terminating the session), enabling a key requirement of action attribution.

There is a long-standing need to provide a solution for continuous access with authentication and action attribution, which has not yet been successfully addressed by conventional solutions. Therefore, existing regulations attempt to address this need by compromising for the existing solutions that are unable to provide a sufficient solution—mainly by enabling operation while requiring an alert when authentication has not been properly completed. While some components of the current embodiment are known and used in various forms, the current embodiment is not a simple combination of existing technologies, but rather a synergy of capabilities with an innovative configuration and operation, facilitating solutions to this long-standing problem of continuous attributable access. The current embodiment includes features to provide multi-level access with or without authentication, maintaining access at various levels of authentication and various levels of authority, and transitioning between multi-level access and authority.

Refer to FIG. 1, a diagram of conventional access to an operational control system (OCS) 104. In general, conventional solutions address the requirement of authenticated continuous access by User1 100 to a shared environment 102 by providing authentication 106 and integrating with domain controllers. However, in these conventional solutions the authentication step is normally done on login—either to a shared environment or to an application. If authentication fails, some solutions may enable operation to support continuous access, but send an alert to a notification or alerting system. However, in this case, the full range of authority is enabled and no limitations are enforced on user actions. As described above, when User1 100 has finished working in the shared environment (for example, when User1's shift has ended), typically User1 100 logs out of the shared environment, and User2 100B logs into the shared environment.

The current embodiment differs from conventional solutions in at least two features: the timing of the authentication step, and enforcing limitations on authority (permissions and/or user operations) for a non-authenticated user.

A feature of the current embodiment is that in addition to providing a solution to the problem of continuous authenticated access, the innovative system and method also facilitate action attribution and a range of choices and flexibility to a customer organization. Attribution of actions to a user supports a key requirement of accountability—acknowledgment and assumption of responsibility for actions by a user. The system can be adapted to the specific needs of the customer, as dictated by the customer's business and operational needs. Depending on the criticality of the operation and the requirement for authentication, different implementations may have different configurations for limitations, triggers, and enforcement. The proposed system and method address the above-mentioned needs by providing a highly configurable solution, which allows varying levels of user interaction prior to authentication, thus enabling the deploying organization to implement the proper balance between the needs of timely response and authentication and action attribution.

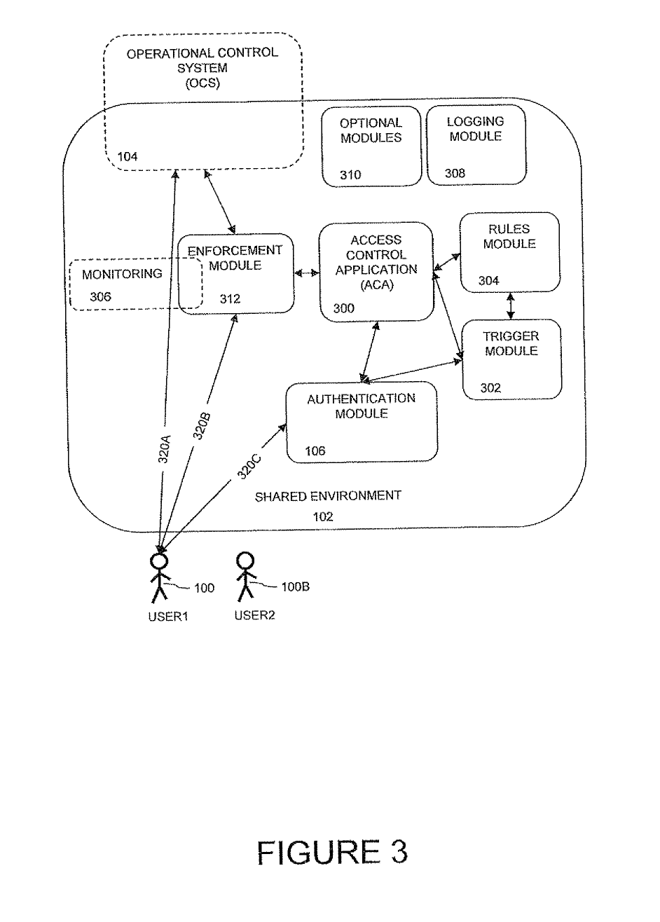

Refer to FIG. 3, an example implementation of a system for providing continuous access and user authentication in shared environments, referred to in this document as Shared Environment Authentication System (SEAS). In a non-limiting typical case, User1 100 is working in shared environment 102, using the operational control system (OCS) 104. User1 100 leaves the shared environment 102 (for example, on shift end) and User2 100E takes over the role of User1. The configurable trigger module 302 can activate a trigger on this change of shift, after several minutes of operation, or according to other logic as dictated by a rules module 304. The trigger starts an authentication process, which includes the access control application (ACA) 300 working with an authentication module 106 and an enforcement module 312 to interact with User2 100B. While User2 100B is not authenticated to the shared environment 102 (or to the OCS 104 specifically, depending on system implementation), the system can be configured based on the rules module 304 so that User2 100B can continue operating and maintain access to the OCS 104. The level of access User2 100B has to the OCS can be configured as well—for example, monitor only/control/allow specific actions and so on. Access and limitations of User2 100B to the shared environment 102 are controlled by the enforcement module 312. User2 100B completes authentication through the authentication module 106, which enables an authority level of User2's specific access and action permissions, as provided by the rules module 304. While a preferable implementation includes enforcement module 312 implemented between User1 100 and OCS 104, as shown by user input 320B being filtered/handled by the enforcement module 312 (known as “man-in-the-middle”), the enforcement module 312 can also be configured to monitor 306 user input 320A between User1 100 and OCS 104 (known as “man-on-the-side”). Optionally, logging module 308 is connected (connections not shown) to one or more of the other modules and records at least a portion of user actions, including user input_{—} Optionally, other optional modules 310, including, but not limited to alert, communication, and interference modules can be included in the SEAS, and operationally connected to one or more other modules (connections not shown).

In the context of this document, references to “user” in general are to any system user, such as User1 100 or User2 100B. For simplicity in this description, users are referred to as human users, however, this does not limit implementations of the embodiment. For example, one or more users can be a software program or an external hardware/firmware/software combination, such as automated tasking and monitoring.

In the context of this document, references to “user input” in general are to any user input by any user, such as user input 320A from a user to the OCS 104, user input 320B from a user to the enforcement module 312, user input 320C from a user to the authentication module 106, and user input to the shared environment (input not shown), including input to the operating system (OS). User input can include, but is not limited to keyboard strokes, mouse movement, starting or stopping processes and applications, accessing files, etc. Note that for simplicity the term “user input” is used, however one skilled in the art will recognize that this reference also can refer to a link that is typically bi-directional, and includes feedback, communications, displays, etc. from OCS 104, enforcement module 312, and authentication module 106. Use of the term “user input” will be obvious to one skilled in the art from the context of use.

In the context of this document, the term “continuous access” generally refers to a requirement that there must be access at all times to the shared environment 102, in particular to the OCS 104. In other words, there cannot be a time when access to the OCS is denied. This continuous access can be pre-defined (pre-determined) by the access rules to provide a minimum level of access to the system.

In the context of this document, the term “shared environment” generally refers to an environment requiring continuous access by multiple users. Typically, the shared environment is a single computer workstation that is sequentially used by multiple users. The shared environment is a combination of one or more machines, operating systems and set of applications that the users interact with to perform the role (job) with which the user is tasked. The shared environment is more generally a system of one or more processors.

In the context of this document, the term “operational control system” (OCS) generally refers to the portion of the system that enables user interaction and control (authority), accepting user commands to control the system, and returning feedback from the system for the user. OCSs include such systems as CCM (command, control, and monitoring) systems.

Note that OCS can refer to software and/or an interface to the hardware of the control system, or to the control system. This is shown in the current diagram by the OCS 104 (represented by a dashed outline) being both inside and outside shared environment 102. One skilled in the art will understand this, and based on this description will be able to implement appropriate interfaces between the SEAS and OCS.

In the context of this document, the term “multi-level access” typically refers to access by more than one user to a system, with each authenticated and un-authenticated user able to have a different level of authority during access to the system, and typically at all times a minimum level of access/authority. While typically multi-level access is for more than one user, this is not limiting in the current embodiment, and a single user may have multiple levels of access to the system, as described below. Authority levels for each user can be the same or different.

In the context of this document, the term “minimum level of access” is a minimum level of authority, typically for any user at any time. This minimum level is typically greater than “no access”. In other words, a minimum level of monitoring and/or control is desired at all times. This typical requirement is not limiting, including the minimum level of access can be “none”, “all”, or any other designated access level.

In the context of this document, the term “pre-determined level of continuous access” generally refers to a level of access defined prior to user operation that any user has at any time. Typically, the minimum level of access is the pre-determined level of continuous access. Typically, this pre-determined level is set at the beginning of system operation. Depending on the specifics of the application, the pre-determined level can be re-set during system operations, affecting the current user(s) of the system or subsequent users.

In the context of this document, the term “triggerable event”, or simply “trigger” generally refers to an event in the shared environment. Triggers (triggerable events) include pre-defined, such as:
time of day;
idle time of the shared environment;
idle time of the OCS;
policy;

and dynamic, such as:
logout of a user;
login of a user;
change of worker, shift manager, or control manager;
detection of user change by other means (such as a change in typing pattern or a detection based on physical camera);
authentication of a user;
failure of a user to authenticate;
function of another application, including the operating system;
change in status of the OCS;
or other triggers;

as well as combinations of the above-listed triggers, referred to in this document as “combinations of triggerable events”.

In the context of this document, the term “access rules” generally refers to rules defining what authority a user can be given. Typically, access rules are pre-defined by an administrator, and based on a combination of one or more characteristics, such as triggers, time of day, idle time of OCS, idle time of shared environment, user, and authentication status of one or more users, status of OCS. Access rules can instantiate control for continuity of workflow. In a preferred implementation, the access rules are stored in a rules module 304.

In the context of this document, the term “authentication” generally refers to verification a user is really who the user claims to be. Authentication techniques are well known in the art (for example, username and password, token, prompt, gesture, biometric reading and many others), and based on this description one skilled in the art will be able to select and implement user authentication appropriate for a specific application.

In the context of this document, the term “authority” generally refers to a level of access allowed to the user, including permissions and/or allowable user operations. Authority/level of access may include, but is not limited to:
only allowing monitoring/display of status for the OCS;
tasking the OCS;
performing actions or commands through the OCS;
changing operating parameters of the OCS;
adding or removing users from the system;
changing authority of users; and
modifying access rules.

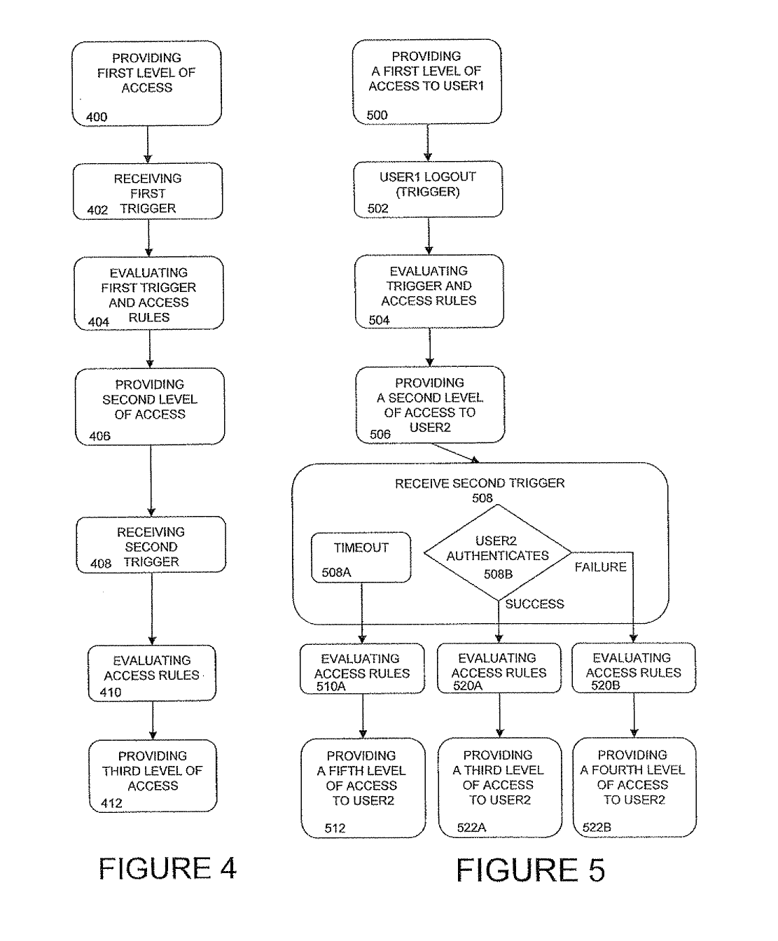

Refer now to FIG. 4, a high-level flowchart of a method for providing continuous access to a shared environment. Following this high-level description is a detailed description based on a typical case, and includes optional features. A method for providing at least a first user with access to a shared environment 102, and in particular to an operational control system (OCS) 104 includes a first step of providing (400) a first level of access to the shared environment. Upon receiving (402) a trigger, the trigger is evaluated (404) with respect to the access rules. Based on this evaluation, a second level of access to the shared environment can be provided (406). Subsequent to providing the second level of access, a second trigger is received 408 and the access rules are evaluated (410). Based on the access rules, and possibly additional trigger(s), a third level of access to the shared environment is provided (412). During these method steps, at least a pre-determined level of continuous access is provided to the shared environment during transition from the first level of access to the second level of access and from the second level of access to the third level of access.

Refer now to FIG. 5, a non-limiting exemplary flowchart of a method for providing continuous access to a shared environment 102, in this example to an operational control system (OCS) 104 in the shared environment 102. For clarity, this description in reference to FIG. 5 is a detailed description based on a typical case of sequential workers (users) accessing a common workstation. One skilled in the art will realize that this description is for simplicity, and does not limit implementations of the embodiment.

A typical case begins with a first worker (first user, User1 100) on shift and performing job functions as necessary for the OCS 104. User1 has a first level of access to the OCS 104, consistent with the responsibilities of Used (500) as defined by the access rules in rules module 304. During this shift (first level of access) worker actions (user input 320A or 320B, depending on implementation) are attributed to User1. At the end of shift, the first worker logs out of the shared environment 102. This logout acts as a trigger (502) to the SEAS. Alternatively, or in combination, access rules may be established based on company policy, such as that every scheduled shift change is a trigger. For example, when the current time is 0800, 1600, or 2400, which are pre-known shift-change times, a trigger is issued. The trigger is evaluated (504) based on access rules to determine if the access level should be changed, and any other optional functions. In this case, the SEAS switches from providing a first level of access to providing (506) a second level of access, and an authentication step is invoked. That is, for a user to access the workstation, authentication will be requested.

Typically, authentication is handled by the authentication module 106. This module is responsible for verifying credentials provided by a user (such as user input 320C), and making a decision whether the user is authenticated or not authenticated. Depending on requirements and implementation, the authentication functions can be performed by the authentication module 106 alone, or functions can be shared with other modules such as the ACA 300 and/or enforcement module 312.

During this second level of access, access from the workstation to the OCS is determined by the access rules and enforced by the enforcement module 312. For example, all system displays may be visible, and any user may be able to request additional status of the OCS 104. Typically, user authority is greatly limited during this second level of access, as compared to user authority during the first level of access.

Subsequent to providing the second level of access, a second trigger is received 508 and the access rules are evaluated (510A, 520A, 520B). Based on the access rules, and possibly additional trigger(s), a third level of access to the shared environment 102 (in this case specifically to the OCS 104) is provided (512, 522A, 522B).

Significantly, during this second level of access, access rules can be established such that if a critical situation occurs in the OCS, any user has permission to make any change via the workstation even though no user is authenticated to the system, so no attribution can be established for which user generated the user input. In this case, the critical situation could be a second trigger. During this second level of access, the access rules can require that a second trigger initiates a user login screen to appear, requiring user authentication to the SEAS. The requirement for user authentication (user login) can vary depending on the access rules. For example, login can be required prior to allowing any user action, or various levels of user authority can be granted prior to login. Combinations of authority can also be granted. For example, for a first period of time, such as 5 minutes, allowing any user action, followed by a second period of time, such as 15 minutes, where a second level of access is enforced, this second level of access is more restrictive than the previous level of access and user authentication is required. In this case, after the first period of 5 minutes timeout 508A serves as second trigger 508, the access rules are evaluated 510A, and a fifth level of access is provided 512, this fifth level corresponding to the second period of 15 minutes. The cycle then can repeat (not shown in the figures), in this case going from block 512 to block 508 with the change that block 508 will now be waiting for the next trigger (instead of the original second trigger). Following this second period of time, based on receiving a next trigger (in this case the end of the second period of 15 minutes) and evaluation of the access rules, all access to the system can be denied (or a minimum level of access enforced) until a user is authenticated.

An incoming worker (any subsequent user, second worker, second user, User2 100B) can monitor the application and continuous monitoring is ensured. However, in the current example, he cannot perform certain actions until authenticated. This period of time during which a second level of access is being provided can also be considered “unauthenticated time”, as no user is authenticated to the system. Correspondingly, during unauthenticated time, an “unauthenticated level of access” can be provided. The incoming worker, User2 attempts to authenticate (508B) to the system via user input 320C. As described above, methods of authentication are known in the art, and will not be elaborated on here. In this case, the attempt of User2 to authenticate 508B can serve as the second trigger 508. Alternatively, the result of the authentication attempt (SUCCESS or FAILURE) can serve as the second trigger 508. If authentication is successful, User2 is authenticated to the system, access rules from the rules module 304 are evaluated (520A) by the ACA 300 to determine the level of access for User2, and optionally other actions. A third level of access is provided (522A) for User2, and all worker actions (user input 320A or 320B) is now attributed to User2. Typically, as shift workers are performing the same job, this third level of access is equivalent to User1's first level of access. In a case where the role of User2 100B is different from the role of User1 100, the third level of access provided to User2 100B can be different from the first level of access provided to User1 100.

If User2 fails to authenticate, the access rules from the rules module 304 are evaluated (520B) by the ACA 300 to determine what action to take, including what level of access should be provided to User2, and optionally other actions such as triggers and logging. A fourth level of access is provided (522B) for User2 and enforced by enforcement module 312. Optionally, all worker actions (user input) is now attributed to an unknown user, or to unauthenticated User2. Other actions can include initiating a trigger 302, such as an alarm, notifying a shift supervisor, etc.

Note also that this embodiment supports single users, such as the case where the same worker is “pulling” a double-shift. In this case, the shift worker User1 100 is the same as shift worker User2 100B. At the end of the first shift, the level of access will change from the first level to the second level, and the shift worker User1 will have to re-authenticate to the system. Based on the access rules, User1 can be provided with User1's typical level of access, or an alternative level of access. One skilled in the art will realize that the system can be designed to allow for change of access during shift, as in this case the shift supervisor may need to change the access rules or activate an exception to the access rules for User1, which can be done ahead of time if known, or during User1's second shift. While in general the SEAS handles any user of the system, in other words, one or more current users of the system, for simplicity and clarity in this description and claims the term “user” or “first user” is used.

An innovative feature of the current embodiment is that the authentication step can be non-intrusive, that is, workflows are enabled during transition from first to second to third levels of access. In general, a pre-determined level of continuous access is defined by the access rules, This pre-determined level is a minimum level of access that the system maintains at all times. Depending on the system implementation, examples of access that can be provided are such that:
the second level of access is the first level of access,
the third level of access is the second level of access,
the first level of access is the pre-determined level of continuous access,
the second level of access is the pre-determined level of continuous access,
the third level of access is the pre-determined level of continuous access,
the first level of access is an unauthenticated level of access,
the second level of access is an unauthenticated level of access,
the third level of access is an authenticated level of access.

The continuity of workflow is defined by the access rules, for example:
Until authenticated, enable monitoring, but not actions—applications in the environment remain visible, but the user cannot interact with applications nor send commands to the applications.
Until authenticated, enable specific actions, but not other actions.
Until authenticated, enable actions, but only for a preset time period, then prevent actions—for example, require the user to authenticate in the first 15 minutes of work on the station
Until authenticated, enable actions for a time period, then initiate an alert. An alert can be to a local station/environment or sent to another system, such as shift manager's station. Alerts can also be sent to the trigger module 302 to serve as a system trigger for activation of other access rules/workflows.
Alternative, additional, and combinations of the above continuity of workflow can also be implemented.

Referring again to FIG. 3, logins and logouts to the shared environment 102 are typically handled by authentication module 106. Login and logout notifications are typically always sent to the trigger module 302, and additionally or optionally, to the ACA 300. Depending on implementation, the trigger module 302, or preferably the ACA 300, can also notify the authentication module, for example, to unauthenticate the current user, and request user authentication.

Typically, the OCS 104 is an existing application/hardware control system, often large, complex, and possibly with a long and varied history. As such, maintaining the OCS 104 interface without modification is desirable. In such a case, preferably the SEAS, and in particular the enforcement module 312 can be designed to interface with users (User1 100, User2 100B) and integrate with any existing OCS 104 interfaces.

The authentication module 106 communicates with the ACA 300, decisions can be made based on the access rules in rules module 304, and other system states and functions can initiate an authentication action (sending a trigger to the authentication module). Success/failure of authentication can initiate a trigger 302, and/or be sent to the ACA 300. Preferably, the ACA is holding state for the system, as opposed to the authentication module 106 informing the rules module 304 or the enforcement module 312. This allocation (configuration of the system/location of maintenance) of the state of the SEAS is not limiting, and depending on the specific application, one or more states may be held in one or more modules of the system. For example, one skilled in the art will realize that while in the current example the functionality for deciding on access and authority of (if and how to) limit user actions is described as being in the ACA 300, this functionality can be implemented in another module such as the authentication module 106, the rules module 304, or the enforcement module 312, with the appropriate connections of user input (320A, 320B) being filtered by “man-on-the-side” or “man-in-the-middle” implementations.

The enforcement module 312 is preferably responsible for enforcing limitations under direction of the ACA 300. The enforcement module 312 can receive commands from the ACA 300 on what limitations to enforce and send ACA 300 information regarding user input (320A, 320B), actions, and related operational information, such as status from the OCS 104. The enforcement module 312 is preferably implemented in a “man-in-the-middle” configuration, as shown by user input 320B. Alternatively, the enforcement module 312 can be implemented in a “man-on-the-side” configuration, as shown by user input 320A going directly from User1 100 to OCS 104, while being monitored 306 by the enforcement module 312. Enforcement can be via a variety of techniques, depending on the specific application. The enforcement module can receive, monitor, and control (enforce or allow) user actions through user input, hooks, and other known mechanisms, such as key strokes, mouse movement, and other actions such as commands, requests, file access, etc. directed to the OCS 104, the shared environment 102, an operating system (not shown) in the shared environment 102, or other module or application in the shared environment.

In the non-limiting example of FIG. 3, user input 320B for the OCS 104 is shown as preferably being filtered/handled by enforcement module 312. Alternatively, the user input 320B can be handled by the access rules module 304, or ACA 300, which then passes the filtered user input to the enforcement module 312 or to the OCS 104, depending on system implementation.

Note that, as described below, even if a user failed authentication, the operational needs of the SEAS/OCS 104 may still dictate (via the access rules) that the un-authenticated user be allowed some level of access and operation. For example, an access level similar to the access level provided prior to the authentication attempt, or with additional limitations. A record can also be created and an alert can be issued, according to organizational needs.

The rules module 304 is a repository for defined access rules used by the SEAS in general, and in particular the ACA 300 and trigger module 302. Access rules can be configurations and/or state changes, as well as all other information needed by the other modules to make operational decisions. The rules module 304 provides a reference for the limiting/enabling of user actions, the authority/level of access to which a user is allowed. Access rules are the instantiation of control for continuity of workflow. In other words, the workflows described above can be considered descriptions of access rules implemented in rules module 304. Varieties of workflow implementations are possible, depending on the application. Based on this description, one skilled in the art will be able to implement a rules module 304 suitable for a specific application, hereby implementing workflows appropriate for the specific application. Non-limiting examples of implementations include: limiting the user actions on the operating system (OS) level, for example by controlling user input (such as keyboard, mouse, specific processes, system calls, etc.). User actions can be limited or enabled on the application level, for example limiting or enabling specific user actions in specific applications. Control on the application level can be done by integration with the specific application, such as the OCS 104, or by using methods to control interaction with a specific application (such as Windows™ hooks, intercepting calls, handles, etc.). Access rules include, but are not limited to:
workflows;
when to trigger authentication;
what limitations of authority/access to enforce;
when and what to log;
how to handle triggers;

The rules module 304 can be implemented as a database, or using other techniques known in the art for business rules construction, maintenance, and storage. The rules module 304 can also be implemented as any other sort of storage, local or network, accessible by the applications and modules which need to retrieve configuration or information on which to base a decision.

The trigger module 302 provides capabilities such as for receiving, storing, initiating, and/or sending triggers to/from all other components of the system. In general, any trigger causes the appropriate portion of the system to consult the access rules, and decide on what action to take based on the trigger and the access rules.

Optional modules 310, such as a user interface module (not shown), can be used by the enforcement module 312 to receive user input and send information to the user. Alternatively, an ACA 300 user interface module or other optional module can prompt the user for input (or gather authentication information regarding the user) and enable the user to enter their credentials for authentication, as opposed to this function being handled by the authentication module 106. Optional modules 310 are connected to other SEAS modules as appropriate.

An optional logging module 308 can be operationally connected to one of more of the SEAS modules. The logging module can simply accept data from other modules, or can be more complicated, parsing logged data and generating analysis results for the ACA 300, the enforcement module 312, or trigger module 302. Alternatively, the other modules can request logged data from the logging module 308. For example, the ACA 300, trigger module 302, enforcement module 312, or authentication module 106 may request data from the logging module for analysis or decision-making. The logging module can store data, or as is known in the art data can be stored locally, attached, and remotely, in a variety of formats from flat text to active database, and at a level of security and redundancy specified by system requirements or regulations. Logged data can be reviewed in real-time (that is, as the data is being logged) or later retrieved for auditing and investigatory purposes, thus enabling attribution that a specific action was performed by a specific user.

Optional and/or alternative features of the SEAS include, but are not limited to the following.

An optional module 310 can be a privileged/shared account management system (PAMS). A PAMS requires the specific user to authenticate, and then enables the usage of shared identity/account (such as “Operator”, “Supervisor”, or “Administrator”). Thus, even though a shared account is used for accessing and operating an asset or application (in this case the OCS 104), the specific user is properly identified and the user's actions can be correctly attributed. Some PAMS (such as a privileged/shared account management system (PIMS), or PIM/PSM solution by CyberArk) enable using a shared account without divulging the shared credentials, thus providing stronger protection and action attribution than using only an authentication module 106. The authentication module 106 in the SEAS communicates with the PAMS to authenticate a user and provide access to the shared credentials needed for accessing and operating the applications in the shared environment 102 (such as the OCS 104). Optionally, PAMS can also provide:
access rules (directly or via the rules module),
authentication to a user while a given level of access is being provided (for example to a first user while a second level of access is being provided),
logging and attribution of actions of a current user (directly, in place of, or working with the logging module), and
monitoring and attribution of actions of a current user (directly, in place of, or working with the logging module and/or enforcement and/or ACA modules).

Other optional modules can be implemented alone, in parallel, or in conjunction with logging module 308, including a user session recording module and monitoring information storage module. Depending on the specific application and implementation, these modules (user session recording and monitoring information storage) can individually communicate with other SEAS modules, or receive and exchange data with the logging module. A monitoring component in the SEAS, such as the ACA 300 (in the case where user input 320B is handled through the ACA 300 to the OCS 104) or the monitoring component 306 of the enforcement module 312, (in a case where user input 320A is monitored 306 by the enforcement module 312) monitors user activity. Monitoring can be fill session video recording, specific protocol recording, or action recording.

Other optional modules include a monitoring module, live session monitoring module, and session control module. The SEAS can be configured with a monitoring module operationally connected to one or more of the other system modules, or integrated as a sub-module in one or more of the other system modules. A live session monitoring module can be critical in sensitive environments where there is often a necessity for a supervisor to be able to monitor in real-time the actions of a specific operator (user) and, if needed, to use a session control module to stop the user's session and prevent further actions. The current embodiment enables live session monitoring and session control by providing a structure in which to implement these modules, with connections to the ACA 300, enforcement module 312, (and or monitoring 306) for control of user input 320A/320B, authentication module 106 and trigger module 302 as necessary.

Another optional module is an interference module. An interference module can include capabilities such as termination of a session if a specific condition is met. For example, if a user attempts to execute a sensitive command to OCS 104, without the user being authenticated, or with insufficient authority. Another non-limiting example is terminating the session based on an external command, such as by an administrator). An interference module can work in parallel, work with, or be a sub-module of the enforcement module 312.

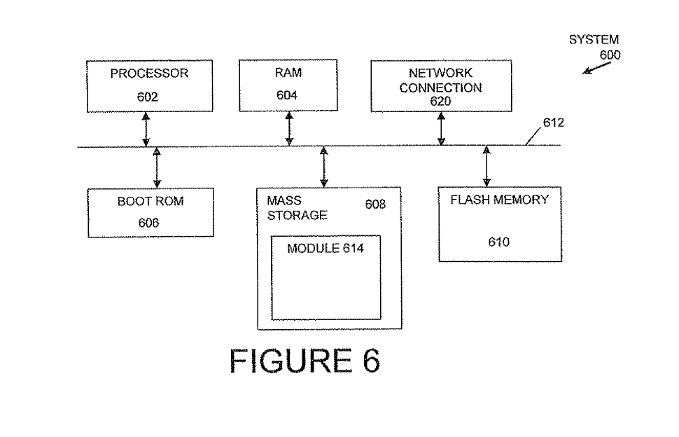

Referring now to the drawings, FIG. 6 is a high-level partial block diagram of an exemplary processing system 600 for implementing a shared environment authentication system (SEAS). The shared environment 102 is generally a system of one or more processors, such as processing system 600. The configuration of processing system 600 includes a processor 602 (one or more) and four memory devices: a RAM 604, a boot ROM 606, a mass storage device (hard disk) 608, and a flash memory 610, all communicating via a bus 612 (one or more). A module (processing module) 614 is shown on mass storage 608, but as will be obvious to one skilled in the art, could be located on any of the memory devices.

Mass storage device 608 is a non-limiting example of a computer-readable storage medium bearing computer-readable code for implementing the continuous multi-level access methodology described herein. Other examples of such computer-readable storage media include read-only memories such as CDs bearing such code.

System 600 may have an operating system stored on the memory devices, the ROM may include boot code for the system, and the processor may be configured for executing the boot code to load the operating system to RAM 604, executing the operating system to copy computer-readable code to RAM 604 and execute the code.

Network connection 620 provides communications to and from system 600. Typically, a single network connection provides one or more links, including virtual connections, to other devices on local and/or remote networks. Alternatively, system 600 can include more than one network connection (not shown), each network connection providing one or more links to other devices and/or networks.

System 600 can be implemented as a server or client respectively connected through a network to a client or server.

As can be seen from the above description, the current embodiment facilitates several innovative features, as compared to conventional solutions.

The SEAS enables workflows required in a specific environment, as defined by access rules, such as prioritization of user interaction options and timely response versus the need for user authentication and action attribution. The SEAS enables continuous operational access and presentation of the current screens, displays, and running applications, with option of user interaction and action before completing authentication. For example, in some implementations in critical and highly sensitive environments, the operator must be able to act immediately if an alert appears and not be required to pass any authentication step, since timely response is more important than authentication and correct action attribution. In other implementations, user authentication and action attribution can be more important, thus no action is allowed until authentication.

The SEAS enables integration with Privileged/Shared Account Management systems, allowing the usage of a shared set of credentials for operating in the shared environment, while maintaining specific user authentication, action attribution, and accountability.

The SEAS enables session monitoring and storage, such as monitoring an entire user session, recording all of part of a user session, or a stream of commands. The logs and monitored sessions can be stored for subsequent auditing and examination.

The SEAS enables live monitoring and termination capability, allowing a supervisor to monitor one or more user sessions in real-time, and, if necessary terminate one or more user sessions

Conventional solutions may solve the problem of keeping a unique user session on a shared machine/environment and enabling several users to use the shared environment by providing for separation of displays, commands, and data. In contrast, the SEAS enables authentication of a specific user who is currently using the shared environment to provide accountability for the user, a critical feature of control/operation centers, such as in critical infrastructure environments. In such environments, there is only one operator who should be using the station at any given time, and when the operator is replaced by another operator (for example at the end of a shift), the organization would like to know who is operating the station now.

An organization may have seemingly contradictory requirements:

1) A need to authenticate and identify the specific operator/user who works in the shared environment—this is important for accountability, access control and more.

2) A need for continuous operational access in the shared environment arises from the criticality of the processes in the shared environment—this need often overrules the needs to authenticate and provide accountability. As a result, many conventional solutions discard proper authentication and instead use shared (=not personalized) accounts. Other implementation may try to deduce the user's identity through other means (for example, shifts schedule and attendance clock).

Where conventional solutions may solve one of these requirements at the expense of the other, the SEAS provides an innovative system and method for satisfying both requirements.

Although in the current description a human user is used, with access control for a plurality of users, it is foreseen that embodiments of the current invention can also be implemented for a plurality of applications, such as software monitoring of the OCS, or a combination of human and software users.

While the current description uses a typical example of multiple users, based on this description one skilled in the art will be able to implement control of continuous access for other cases such as a single user, or multiple simultaneous users. For example, access rules can define that a single user may have different levels of access during different times of the day. A user who normally works during the day is allowed full access to the OCS during day shift, but during evening and overnight shifts is only allowed to monitor the OCS. If this user desires additional access during normally off-hours, the access control application (ACA) may grant or deny the additional access (based on the pre-defined access rules), as well as optionally sending an alert.

The above-described SEAS components, such as ACA, enforcement, trigger, authentication, and access rules, are generally modules within the system. Note that a variety of implementations for modules and processing are possible, depending on the application. Modules are preferably implemented in software, but can also be implemented in hardware and firmware, on a single processor or distributed processors, at one or more locations. In general, the SEAS system includes a processing system containing one or more processors, the processing system being configured with one or more modules. The above-described module functions can be combined and implemented as fewer modules or separated into sub-functions and implemented as a larger number of modules, in a distributed or unified manner. Based on the above description, one skilled in the art will be able to design an implementation for a specific application.

It should be noted that the above-described examples, numbers used, and exemplary calculations are to assist in the description of this embodiment. Inadvertent typographical and mathematical errors do not detract from the utility and basic advantages of the invention.

To the extent that the appended claims have been drafted without multiple dependencies, this has been done only to accommodate formal requirements in jurisdictions that do not allow such multiple dependencies. It should be noted that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1-23. (canceled)

24. A method comprising the steps of:
(a) providing a user a first level of access to a shared environment;
(b) receiving a first trigger while providing said first level of access;
(c) providing the user a second level of access to the shared environment based on said first trigger and access rules;
(d) receiving a second trigger while providing said second level of access;
(e) providing the user a third level of access to the shared environment based on said second trigger and said access rules,
wherein at least a pre-determined level of continuous access to the shared environment is provided to the user during transition:
(i) from said first level of access to said second level of access; and
(ii) from said second level of access to said third level of access.

25. The method of claim 24 wherein said first and second triggers are selected from the group consisting of:
(i) time of day;
(ii) idle time of the shared environment;
(iii) idle time of an operational control system (OCS) associated with the shared environment;
(iv) authentication of the user;
(v) failure of the user to authenticate;
(vi) login of any user to the shared environment;
(vii) logout of any user from the shared environment;
(viii) time since the user was requested to authenticate;
(ix) change in status of the shared environment;
(x) change in status of an operational control system (OCS) associated with the shared environment;
(xi) action or actions of the user in the shared environment
(xii) action or actions of the user associated with an operational control system (OCS) associated with the shared environment;
(xiii) command external to the shared environment;
(xiv) any system trigger based on said access rules; and
(xv) a combination of triggerable events.

26. The method of claim 24 wherein said second trigger is:
(a) an indication the user has authenticated to the shared environment; or is
(b) an indication the user has failed authentication to the shared environment; or is
(c) based on said access rules.

27. The method of claim 24 wherein said first level of access includes allowing any user said pre-determined level of continuous access to the shared environment.

28. The method of claim 24 wherein said first level of access includes allowing the user said pre-determined level of continuous access to the shared environment while the user is unauthenticated.

29. The method of claim 24 wherein while said second level of access is being provided, the user is required to authenticate for said third level of access.

30. The method of claim 29 wherein:
(a) if the user is successful in authenticating, said third level of access is provided; and
(b) if the user fails authentication a fourth level of access is provided based on said access rules

31. The method of claim 30 further including the steps of:
(a) when said third level of access is provided, receiving a third trigger indicating that the user has logged out from the shared environment;
(b) providing said first level of access to a subsequent user of the shared environment.

32. The method of claim 24 wherein actions of a current user are logged and attributed to said current user.

33. The method of claim 24 wherein actions of a current user are monitored and attributed to said current user.

34. The method of claim 24 wherein user actions are prevented or changed according to said access rules or an external command.

35. The method of claim 24 wherein access is provided such that:
(a) said second level of access is said first level of access; or such that
(b) said third level of access is said second level of access; or such that
(c) said first level of access is said pre-determined level of continuous access; or such that
(d) said second level of access is said pre-determined level of continuous access; or such that
(e) said third level of access is said pre-determined level of continuous access; or such that
(f) said first level of access is an unauthenticated level of access; or such that
(g) said second level of access is an unauthenticated level of access; or such that
(h) said third level of access is an authenticated level of access.

36. The method of claim 24 wherein a Privileged Account Management System (PAMS) provides at least one of:
(a) said access rules;
(b) authentication to the user while said second level of access is being provided;
(c) logging and attribution of actions of the user; and
(d) monitoring and attribution of actions of the user.

37. The method of claim 24 wherein the user is a human.

38. The method of claim 24 wherein the user is a computer application.

39. The method of claim 24 wherein the shared environment is a computer system.

40. A system comprising:
(a) a rules module configured to receive, store, and provide access rules;
(b) a trigger module configured to receive, store, and provide triggers;
(c) an enforcement module operational to control user input based on an access level, said enforcement module providing a user a first level of access to a shared environment;
(d) an access control application module (ACA) operationally connected to said rules module, said trigger module, and said enforcement module, said ACA configured to:
(i) receive a first trigger from said trigger module while said first level of access is being provided;
(ii) based on said first trigger, receive a first access rule from said rules module;
(iii) based on said first access rule, initiate said enforcement module to provide the user a second level of access to the shared environment;
(iv) based on a second trigger, receive a second access rule from said rules module while said second level of access is being provided;
(v) based on said second access rule, initiate said enforcement module to provide the user a third level of access to the shared environment;
wherein at least a pre-determined level of continuous access to the shared environment is provided to the user during transition:
(A) from said first level of access to said second level of access; and
(B) from said second level of access to said third level of access.

41. The system of claim 40 wherein said enforcement module monitors user input.

42. The system of claim 40 further including a monitoring module configured to monitor user input.

43. The system of claim 40 further including an authentication module operationally connected to said trigger module and configured to send triggers to said trigger module based on success or failure of the user to authenticate.

44. The system of claim 40 further including a logging module configured to receive, store, and/or transmit data from one or more of the modules.

45. The system of claim 40 wherein said first and second triggers are selected from the group consisting of:
(i) time of day;
(ii) idle time of the shared environment;
(iii) idle time of an operational control system (OCS) associated with the shared environment;
(iv) authentication of the user;
(v) failure of the user to authenticate;
(vi) login of any user to the shared environment;
(vii) logout of any user from the shared environment;
(viii) time since the user was requested to authenticate;
(ix) change in status of the shared environment;
(x) change in status of an operational control system (OCS) associated with the shared environment;
(xi) action or actions of the user in the shared environment
(xii) action or actions of the user associated with an operational control system (OCS) associated with the shared environment;
(xiii) command external to the shared environment;
(xiv) any system trigger based on said access rules; and
(xv) a combination of triggerable events.

46. The system of claim 40 wherein said second trigger is:
(a) an indication said user has authenticated to the shared environment; or is
(b) an indication said user has failed authentication to the shared environment; or is
(c) based on said access rules.

47. The system of claim 40 wherein said first level of access includes allowing any user said pre-determined level of continuous access to the shared environment.

48. The system of claim 40 wherein said first level of access includes allowing the user said pre-determined level of continuous access to the shared environment while the user is unauthenticated.

49. The system of claim 40 wherein while said second level of access is being provided, the user is required to authenticate for said third level of access.

50. The system of claim 49 wherein:
(a) if the user is successful in authenticating, said third level of access is provided; and
(b) if the user fails authentication a fourth level of access is provided based on said access rules.

51. The system of claim 50 wherein said ACA is further configured to:
(a) when said third level of access is provided, receive a third trigger indicating that the user has logged out from the shared environment;
(b) provide said first level of access to a subsequent user of the shared environment.

52. The system of claim 40 wherein actions of a current user are logged and attributed to said current user.

53. The system of claim 40 wherein actions of a current user are monitored and attributed to said current user.

54. The system of claim 40 wherein user actions are prevented or changed according to said access rules or an external command.

55. The system of claim 40 wherein access is provided such that:
(a) said second level of access is said first level of access; or such that
(b) said third level of access is said second level of access; or such that
(c) said first level of access is said pre-determined level of continuous access; or such that
(d) said second level of access is said pre-determined level of continuous access;
or such that
(e) said third level of access is said pre-determined level of continuous access; or such that
(f) said first level of access is an unauthenticated level of access; or such that
(g) said second level of access is an unauthenticated level of access; or such that
(h) said third level of access is an authenticated level of access.

56. The system of claim 40 wherein a Privileged Account Management System (PAMS) provides at least one of:
(a) said access rules;
(b) authentication to the user while said second level of access is being provided;
(c) logging and attribution of actions of the user; and
(d) monitoring and attribution of actions of the user.

57. The system of claim 40 wherein the user is a human.

58. The system of claim 40 wherein the user is a computer application.

59. The system of claim 40 wherein the shared environment is a computer system.

60. A computer-readable storage medium having embedded thereon computer-readable code for providing access, the computer readable code comprising program code for:
(a) providing a user a first level of access to a shared environment;
(b) receiving a first trigger while providing said first level of access;
(c) providing the user a second level of access to the shared environment based on said first trigger and access rules;
(d) receiving a second trigger while providing said second level of access;
(e) providing the user a third level of access to the shared environment based on said second trigger and said access rules,
wherein at least a pre-determined level of continuous access to the shared environment is provided to the user during transition:
(i) from said first level of access to said second level of access; and
(ii) from said second level of access to said third level of access.
